(19) United States
(12) Patent Application Publication
(10) Pub. No.: US 2024/0035746 A1
(43) Pub. Date: Feb. 1, 2024

(54) ENCLOSURE FOR A COLUMN FOR LOW-TEMPERATURE DISTILLATION

(71) Applicant: L'Air Liquide, Societe Anonyme pour l'Etude et l’Exploitation des Procedes Georges Claude, Paris (FR)

(72) Inventors: Dominique LE LARGE, Champigny sur Marne (FR); Remy KURTZ, Champigny sur Marne (FR)

(73) Assignee: L'Air Liquide, Societe Anonyme pour l'Etude et l’Exploitation des Procedes Georges Claude, Paris (FR)

(21) Appl. No.: 18/227,387

(22) Filed: Jul. 28, 2023

(30) Foreign Application Priority Data
Jul. 29, 2022 (FR) FR2207855

(51) Int. Cl. F25J 3/04

(52) U.S. Cl. CPC F25J 3/04945; F25J 3/0489; F25J 3/04872; F25J 2290/30; F25J 2290/44

(57) ABSTRACT

An enclosure for a column for low-temperature distillation comprises a distillation column, which has a circular cross section and is to be thermally insulated, the column containing liquid during use, at least one pipe attached to the column for transporting a liquid, a parallelepipedal casing enclosing the column in a sealed manner, pulverulent thermal insulation filling the space between the column or columns and the casing, a liquid-retaining tank, which has a flat bottom and four side walls, defining a liquid-retaining space, the tank being arranged inside the casing below the column in order to collect liquid that has leaked from the column, the tank being made from stainless steel or from aluminium and the casing being made from carbon steel, the column resting on the bottom of the tank through a skirt, the skirt being a cylinder made from stainless steel and having the same diameter as the column, the liquid-retaining space containing pulverulent thermal insulation.

### CROSS REFERENCE TO RELATED APPLICATIONS

This application claims the benefit of priority under 35 U.S.C. § 119 (a) and (h) to French patent application No. FR2207855, filed Jul. 29, 2022, which is herein incorporated by reference in its entirety.

### FIELD OF THE INVENTION

The present invention relates to an enclosure for a column for low-temperature distillation, i.e. at temperatures below 0° C., or even −100° C., down to an order of magnitude of −192° C.

The distillation column may be an air distillation column or a column for distilling a mixture containing hydrogen and/or carbon monoxide and/or carbon dioxide and/or methane.

### BACKGROUND OF THE INVENTION

As noted in the article “Managing Enterprise Risk” by S. B. Harrison in gasworld, May 2020, in certain cases a low-temperature distillation column may experience leakages of cryogenic liquid and the accumulation of cryogenic liquid in the enclosure of the column may cause the enclosure to explode and/or heavy items of equipment (the columns, the exchangers, the pots) to collapse. In the case of a mixture containing carbon monoxide, the toxicity of the fluid poses an increased risk.

It is known practice for offshore air separation units to have the column arranged inside an enclosure insulated by insulation blocks held between a double wall comprising two walls, the lower part of the inner wall being made from stainless steel. Units of this kind are described in “The Safe and Efficient Provision of Oxygen for Remote, Offshore Conversion of Natural Gas” by P. G. Goldstone, presented at the “Remote and Stranded Gas Reserves Conference”, 1998 and in WO99/66154.

In addition, “Tonnage Nitrogen Generation for Oil and Gas Enhanced Recovery in the North Sea” by P. Goldstone et al discloses the use of a liquid container designed to contain the entire stock of liquid of a column.

WO99/26033 discloses installing solid insulation at the bottom of an enclosure that uses a double wall, with the space between the walls filled with perlite.

### SUMMARY OF THE INVENTION

One aim of certain embodiments of the present invention is to provide a solution for containing leakages of low-temperature liquid for an enclosure insulated with perlite, this being the normal manner of insulating an air separation column.

The inventors have discovered that a tank of relatively small dimensions containing pulverulent thermal insulation was able to sufficiently contain leakages from a distillation column. Specifically, the liquid from the leakages is partially absorbed by the pulverulent insulation, for example perlite, such that the coldness of the liquid is not transferred to the structure of the enclosure. In particular, this allows carbon steel to be used as a material for the casing of the enclosure surrounding the column, whereas previously at least the framework of the casing below the elements liable to leak was made from stainless steel.

According to one subject of the invention, an enclosure is provided for a column for distillation at a temperature below 0° C. comprising at least one distillation column, which has a circular cross section and is to be thermally insulated, the column being designed to contain liquid during use, at least one pipe attached to the at least one column for transporting a liquid, a parallelepipedal casing enclosing the at least one column in a sealed manner, pulverulent thermal insulation filling the space between the column or columns and the casing, a liquid-retaining tank, which has a rectangular bottom and four side walls, defining a liquid-retaining space, the tank being arranged inside the casing, below the at least one column and/or at least part of the pipe, and being designed to collect liquid that has leaked from the column and/or from the pipe, the tank being made from stainless steel or from aluminium and the casing being made from carbon steel, the at least one column resting on the flat bottom of the tank through a skirt, the skirt being a cylinder made from stainless steel or from aluminium and having the same diameter as, or a larger diameter than, the column, the liquid-retaining space containing pulverulent thermal insulation.

According to other optional aspects, the invention may contain one or more of the following:
the tank is dimensioned to contain at most a volume of liquid corresponding to at most 5% of the volume of the column,
the space between the skirt of the column or columns and the tank contains pulverulent thermal insulation,
the tank rests on supports made from stainless steel or from aluminium,
the tank is attached to the casing by way of metal elements, for example made from stainless steel or from aluminium,
the tank comprises four walls extending in the direction of the axis of the at least one column, the four walls being attached to the periphery of the rectangular bottom, the four walls being planar walls,
the tank comprises four walls extending in the direction of the axis of the at least one column, the four walls being attached to the periphery of the rectangular bottom and having a concavity in which a metal frame can be housed,
the casing is entirely made from carbon steel,
the enclosure comprises means connected to the tank for detecting the presence of liquid and for triggering an alarm signal,
the casing is exposed to the open air,
the tank is welded to the casing,
the tank rests on the framework of the casing rather than being welded to the casing, and
the tank rests on a foundation slab.

According to another subject of the invention, a method is provided for separating a mixture containing carbon monoxide and at least one other component, wherein the mixture is separated by distillation at a temperature below 0° C. in a column contained in an enclosure as described hereinabove.

### BRIEF DESCRIPTION OF THE DRAWINGS

Other features and advantages of the invention will be further disclosed in the description that follows, and in several embodiments provided as non-limiting examples in reference to the appended schematic drawings, in which:

FIG. 1 schematically shows an enclosure according to the invention.

FIG. 2 schematically shows a view of the exterior of the lower part of an enclosure according to the invention.

FIG. 3 schematically shows a view of the exterior of the lower part of an enclosure according to the invention.

FIG. 4 schematically shows a vertical section of the lower part of an enclosure according to the invention.

FIG. 5 schematically shows a top view of the interior of the lower part of an enclosure according to the invention.

FIG. 6 schematically shows a vertical section of an edge of the lower part of an enclosure according to the invention.

### DETAILED DESCRIPTION OF THE INVENTION

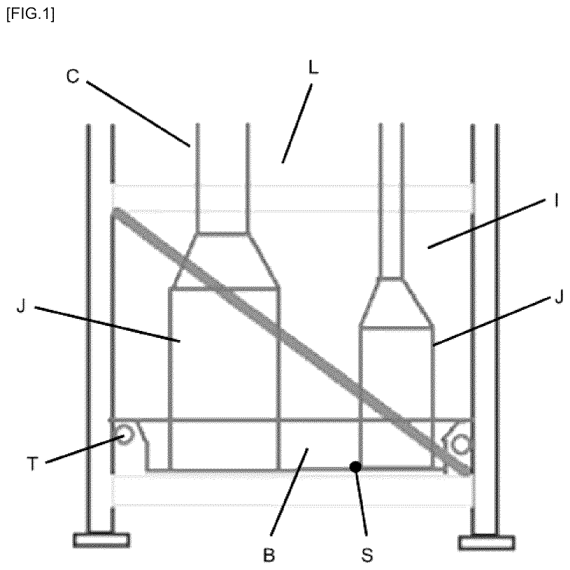

FIG. 1 illustrates an enclosure for a low-temperature distillation column, for example a column for separating air or a mixture of air gases, such as nitrogen and/or oxygen and/or argon. The mixture to be separated may also contain carbon monoxide and/or hydrogen and/or carbon dioxide and/or nitrogen and/or methane as main components. The enclosure contains at least one distillation column C to be insulated containing liquid during use. The column has a cylindrical shape and contains trays or structured packings, typically having a height of at least 2 m, or even at least 10 m. The column 1 is arranged with the axis thereof vertical in a parallelepipedal casing Q made from carbon steel and consisting of sheets mounted on a framework. This casing encloses pulverulent thermal insulation I, for example perlite, which fills the space around the column C in the casing Q. The casing Q encloses the column C surrounded by insulation I in a sealed manner and contains means for sending nitrogen into the insulation I in order to drive cryogenic leakages towards the top of the casing Q, which comprises means for discharging into the atmosphere.

At least one pipe L is attached to the columns C, this pipe being able to direct a liquid towards the column or withdraw a liquid from the column C. It will be appreciated that the pipe L may be connected to just one of the columns. A liquid-retaining tank B with a rectangular bottom is arranged inside the casing Q below the column C and at least part of the pipe L in order to collect liquid that has leaked from the column and/or from the pipe, the tank B being made from stainless steel or from aluminium and the casing being made from carbon steel. The tank comprises four vertical walls attached to the periphery of the rectangular bottom, the four walls being nonplanar walls. The tank B thus makes it possible to retain an amount of liquid that has leaked and fallen from the column C and/or from the pipe L.

If the tank B contracts upon receiving cryogenic liquid, it is held in place by a frame T, for example made of metal tubing that surrounds the tank B. Each wall comprises a concave part in which the frame T made of tubing can be housed.

The tank B is in contact with the casing Q, which is exposed to the open air, resulting in the tank B receiving ambient heat.

The tank B does not comprise any means for discharging the liquid that has accumulated in the tank through the bottom or a wall of the tank.

The column C is welded onto the bottom of the tank by means of a cylindrical skirt J that has the same diameter as the column and is attached to the bottom of the column C. The skirt may also be bolted to the bottom F of the tank.

The space between the bottom end of the column C, the bottom F of the tank B and the wall of the skirt J contains, or is even filled with, pulverulent thermal insulation I. The portion of the tank B around the skirt J is also filled with pulverulent thermal insulation I.

The tank is dimensioned so as to be able to contain only a small fraction of the liquid contained in the column C during distillation. However, the tank is only required to contain small amounts of liquid that have leaked from the column C or from the part of the pipe L above the tank B. Furthermore, the insulation I has an absorption capacity that allows it to reduce the amount of liquid reaching the bottom of the tank B. The pulverulent insulation, for example perlite, thus expands upon absorbing at least some of the liquid. During use, the liquid is vaporized in the metal tank that is in contact with the casing Q and is therefore at ambient temperature or a temperature close to ambient temperature. The vaporized liquid rises in the casing, entrained by the nitrogen, and exits via the discharging means E at the top of the casing.

The insulation I arranged below the column C inside the skirt J prevents heat from being transferred from the bottom of the tank B to the column.

The liquid from the leakage may be air, nitrogen, oxygen, methane, carbon monoxide, carbon dioxide or hydrogen.

A liquid detector S triggers an alarm on the basis of the amount of liquid in the tank B in order to warn a member of staff. The member of staff can then intervene to remove the liquid that has accumulated in the tank B by opening a tap leading to a liquid vaporizer. As an alternative, this operation may be automated. The detector S may alternatively detect a drop in pressure that indicates leakage of liquid. In this case, operators are able to protect the structure that is liable to come into contact with leakages of liquid.

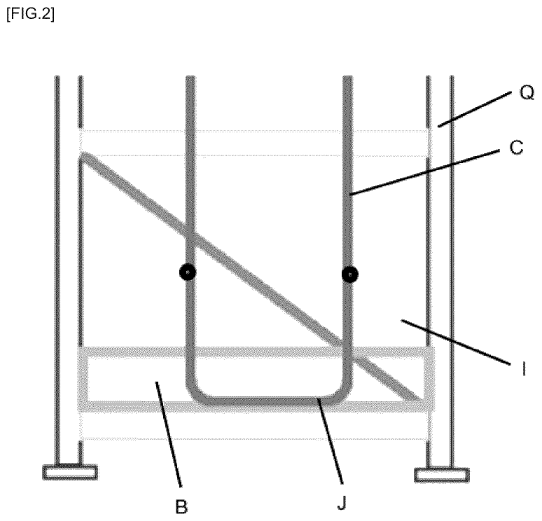

FIG. 2 illustrates a variant of FIG. 1 in which the enclosure contains only a single column C, the skirt J thereof having the same diameter as the column. In this case, the walls of the tank B are planar.

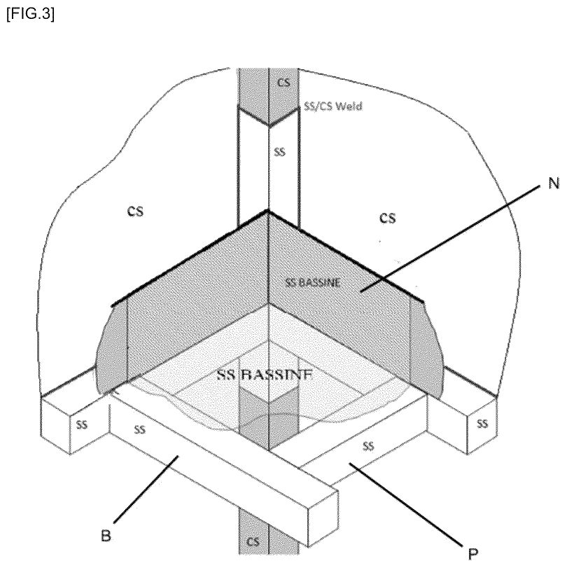

FIG. 3 shows the elements of the enclosure that are made from stainless steel SS or from aluminium and those that are made from carbon steel CS. The bottom F and the vertical walls N of the tank B are made from stainless steel or from aluminium whereas the uprights of the framework of the casing are made from carbon steel. All of the elements that are in direct contact with the tank B are also made from stainless steel or from aluminium, namely the supports P.

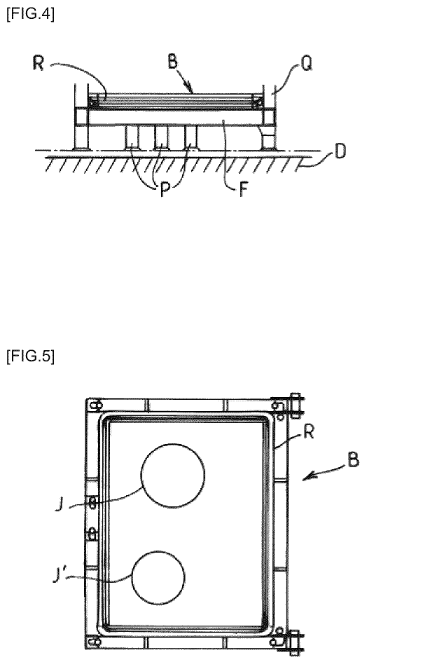

FIG. 4 shows a view of one variant of the tank from outside of the tank. The tank B is mounted inside the casing Q on supports P made from stainless steel or from aluminium. These supports P may be attached directly to the casing Q or may otherwise rest on the foundation slab D of the column. The tank has a rectangular base and four nonplanar side walls, which terminate in a rim R that is in contact with the casing Q, in order to prevent liquid from passing around the tank B. The tank B also serves to prevent leakages of liquid from falling on the slab D and weakening it. The tank B preferably comprises a fluid-drainage pipe for removing liquid that has accumulated therein.

FIG. 5 shows the skirts J, J′ of two distillation columns with different diameters, the two columns being inside one enclosure and the tank having a rim as shown in [FIG. 4].

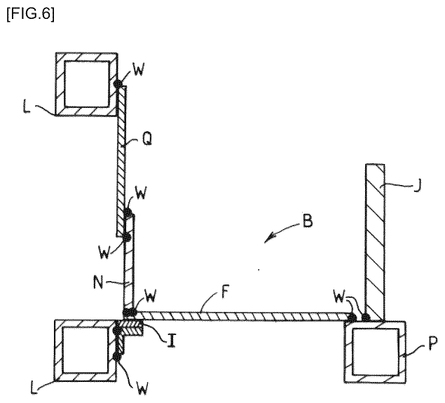

FIG. 6 shows the welding points W that are required to fasten the tank B in another variant to the casing Q. The casing Q comprises a framework composed of beams L. The planar side wall N of the tank B is welded against the casing Q and to the bottom F of the tank B. The bottom F is also welded to the support P from [FIG. 4], to which the skirt J is welded. The bottom F comprises a circular opening, which has the same diameter as the skirt J, below the skirt in order to reduce the weight of the assembly.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. An enclosure for a column for distillation at a temperature below 0° C. comprising:
at least one distillation column, which has a circular cross section and is to be thermally insulated, the column being configured to contain liquid during use;
at least one pipe attached to the at least one column for transporting a liquid;
a parallelepipedal casing enclosing the at least one column in a sealed manner;
pulverulent thermal insulation filling the space between the column or columns and the casing; and
a liquid-retaining tank, which has a flat rectangular bottom and four side walls, defining a liquid-retaining space, the tank being arranged inside the casing, below the at least one column and/or at least part of the pipe, and being configured to collect and accumulate liquid that has leaked from the column and/or from the pipe, the tank being made from stainless steel or from aluminium and the casing being made from carbon steel,
wherein the at least one column rests on the bottom of the tank through a skirt, the skirt being a cylinder made from stainless steel or from aluminium and having the same diameter as, or a larger diameter than, the column,
wherein the liquid-retaining space contains pulverulent thermal insulation.

2. The enclosure according to claim 1, wherein the tank is dimensioned to contain at most a volume of liquid corresponding to at most 5% of the volume of the column.

3. The enclosure according to claim 1, wherein the space between the skirt of the column and the tank contains pulverulent thermal insulation.

4. The enclosure according to claim 1, wherein the tank rests on supports made from stainless steel or from aluminium.

5. The enclosure according to claim 1, wherein the tank is attached to the casing by way of metal elements, for example made from stainless steel or from aluminium.

6. The enclosure according to claim 1, wherein the tank comprises four walls extending in the direction of the axis of the at least one column, the four walls being attached to the periphery of the rectangular bottom, the four walls being planar walls.

7. The enclosure according to claim 1, wherein the tank does not comprise any downward openings.

8. The enclosure according to claim 1, further comprising means connected to the tank for detecting the presence of liquid and for triggering an alarm signal.

9. The enclosure according to claim 1, wherein the casing is exposed to the open air.

10. A method for separating a mixture containing carbon monoxide and at least one other component, wherein the mixture is separated by distillation at a temperature below 0° C. in a column contained in an enclosure according to claim 1.
